(19) United States
(12) Patent Application Publication
(10) Pub. No.: US 2004/0186939 A1
(43) Pub. Date: Sep. 23, 2004

(54) Method and apparatus for communications interfacing capable of effectively reducing disk drive power consumption

(76) Inventors: Isamu Miyanishi, Osaka (JP); Kazuyuki Nakahara, Osaka (JP)

Correspondence Address: Ivan S. Kavrukov, Esq., Cooper & Dunham LLP, 1185 Avenue of the Americas, New York, NY, 10036, US

(21) Appl. No.: 10/799,852

(22) Filed: Mar. 12, 2004

(30) Foreign Application Priority Data
Mar. 17, 2003 (JP) 2003-072141

(51) Int. Cl. G06F 3/00

(52) U.S. Cl. 710/100

(57) ABSTRACT

A communications interface apparatus includes a register, first and second memories, and a control circuit. The register circuit stores data to be transferred to a host computer. The first memory stores first information indicating a specific address of the register and representing an access to the apparatus executed by the host computer for a data transfer. The second memory stores second information, sent from the host computer in association with the first information stored in the first memory, to be written into the register at the specific address indicated by the first information stored in the first memory. The control circuit performs an information writing operation for writing the first information into the first memory and the second information into the second memory in chronological order of accesses executed.

### BACKGROUND

1. Field

This patent specification describes a method and apparatus for communications interfacing, and more particularly to a method and apparatus for communications interfacing capable of effectively reducing a power consumption of an optical disk drive mechanism.

2. Discussion of the Related Art

Generally, conventional optical disk drive apparatuses have a low power consumption mode to attempt to minimize power consumption during the time the apparatuses are on standby. One effective power saving approach for a low power consumption state is to reduce a frequency of a clock signal used in a conventional optical disk drive apparatus. The conventional optical disk drive apparatus, however, needs to operate with a relatively high frequency clock signal since a data transfer between the conventional optical disk drive apparatus and a host computer connected thereto is usually performed at a relatively high transfer rate. Therefore, the conventional optical disk drive apparatus typically cannot switch into the low power consumption mode operating with a high frequency clock signal when executing a data transfer from and/or to the host computer.

One attempt to minimize power consumption in the conventional optical disk drive apparatus is to reduce a frequency of the clock signal in a first portion of circuitry which does not handle a data receiving operation to receive data such as commands from the host computer, while maintaining the frequency of the clock signal at an appropriate standard frequency in a second portion of circuitry which handles the data receiving operation. With this structure, the conventional apparatus can properly operate the data transfer with the host computer by returning the frequency of the clock signal used in the first portion of circuitry to the standard frequency on an as needed basis after an analysis of data upon receiving the data from the host computer.

In general, the second portion of circuitry in the above-described case generally is relatively large and therefore the above attempt produces a relatively small effect of minimizing the power consumption. In addition, this attempt has a drawback of taking too long a time since it needs to determine whether the frequency of the clock signal is increased to the standard frequency after analyzing the command received from the host computer.

In order to avoid the problem of other conventional approaches that have a relatively small effect, an asynchronous data receiving operation is implemented in some conventional optical disk drive apparatuses. However, the asynchronous data transfer has a drawback of sensitivity against external noises.

### SUMMARY

This patent specification describes a novel communications interface apparatus which includes a register, first and second memories, and a control circuit. The register circuit stores data to be transferred to a host computer. The first memory stores first information indicating a specific address of the register and representing an access to the apparatus executed by the host computer for a data transfer. The second memory stores second information, sent from the host computer in association with the first information stored in the first memory, to be written into the register at the specific address indicated by the first information stored in the first memory. The control circuit is configured to perform an information writing operation for writing the first information into the first memory and the second information into the second memory in chronological order of accesses executed.

The control circuit may perform the information writing operation to write the first information into the first memory and the second information into the second memory in chronological order of accesses executed, when an operation mode of the apparatus is changed from a low power consumption mode to a regular operation mode.

The control circuit may perform an information reading operation for reading the first and second information written in the first and second memories, respectively, in chronological order of the accesses executed and an information transfer operation to transfer the first and second information read from the first and second memories, respectively, to the register in chronological order of the accesses executed, when the operation mode of the apparatus is changed from the low power consumption mode to the regular operation mode.

Each of the first and second memories may include a first-in and first-out memory including a specific number of buffer areas into which data from the host computer is written, and the control circuit conducts the information writing operations with respect to the first and second memories in synchronism with each other and the information reading operations with respect to the first and second memories in synchronism with each other.

The control circuit may access the first and second memories in synchronism with a first clock signal for the information writing operation and a second clock signal for the information reading operation such that a first frequency of the first clock signal is greater than a second frequency of the second clock signal.

The control circuit may transfer the first and second information directly to the register without buffering the first and second information in the first-in and first-out memories of the first and second memories at an event that the respective first-in and first-out memories of the first and second memories are in a memory empty state after the first and second information stored in the respective first-in and first-out memories of the first and second memories, respectively, are transferred to the register when the operation mode of the apparatus is changed from the low power consumption mode to the regular operation mode.

Each of the first and second memories may include a selection circuit configured to select one of a first data path for the first and second information not via the first and second memories and a second data path for the first and second information via the respective first and second memories on an exclusive basis according to a control signal from the control circuit and to output corresponding data to the register through one of the first and second data paths selected.

The control circuit may include a data writing circuit block, a data reading circuit block, a status detecting circuit block, and a selection control circuit block. The data writing circuit block is configured to write the first and second information into the first and second memories, respectively, in accordance with an access performed by the host computer. The data reading circuit block is configured to start reading the first and second information from the first and second memories, respectively, upon a time the write control circuit block starts writing the first and second information into the first and second memories, respectively. The status detecting circuit block is configured to detect memory statuses of the first-in and first-out memories included in the respective first and second memories and to output a status signal representing the memory statuses detected. The selection control circuit block is configured to control the selection circuits included in the respective first and second memories in accordance with a status as to whether the operation mode of the apparatus is the low power consumption mode and the status signal output from the status detecting circuit block.

The register, the first and second memories, and the control circuit may be integrated into a single integrated chip.

The patent specification also describes a novel communications interfacing method which includes the steps of installing, providing, and performing. The installing step installs a register circuit storing data to be transferred to a host computer. The providing step provides a first memory storing first information indicating a specific address of the register and representing an access to the apparatus executed by the host computer for a data transfer, and a second memory storing second information, sent from the host computer in association with the first information stored in the first memory, to be written into the register at the specific address indicated by the first information stored in the first memory. The performing step performs an information writing operation with a control circuit for writing the first information into the first memory and the second information into the second memory in chronological order of accesses executed.

The performing step may perform the information writing operation to write the first information into the first memory and the second information into the second memory in chronological order of accesses executed, when an operation mode of the apparatus is changed from a low power consumption mode to a regular operation mode.

The optical communications interfacing method may further include the steps of executing and conducting. The executing step executes an information reading operation with the control circuit for reading the first and second information written in the first and second memories, respectively, in chronological order of the accesses executed by the performing step. The conducting step conducts an information transfer operation with the control circuit for transferring the first and second information read from the first and second memories, respectively, performed by the executing step to the register in chronological order of the accesses executed, when the operation mode of the apparatus is changed from the low power consumption mode to the regular operation mode.

Each of the first and second memories may include a first-in and first-out memory including a specific number of buffer areas into which data from the host computer is written by the performing step. In this case, the performing step performs the information writing operations with respect to the first and second memories in synchronism with each other and the executing step executes the information reading operations with respect to the first and second memories in synchronism with each other.

The performing step may use a first clock signal for synchronizing the information writing operation and the executing step uses a second clock signal for synchronizing the information reading operation. In this case, a first frequency of the first clock signal is greater than a second frequency of the second clock signal.

The data writing operation performed by the performing step may transfer the first and second information directly to the register without buffering the first and second information into the first-in and first-out memories of the first and second memories at an event that the respective first-in and first-out memories of the first and second memories are in a memory empty state after the first and second information written in the respective first-in and first-out memories of the first and second memories, respectively, are transferred to the register when the operation mode of the apparatus is changed from the low power consumption mode to the regular operation mode.

The novel communications interfacing method may further include the steps of generating, selecting, and outputting. The generating step generates a selection control signal using the control circuit. The selecting step selects one of a first data path for the first and second information not via the first and second memories and a second data path for the first and second information via the respective first and second memories on an exclusive basis according to the selection control signal. The outputting step outputs corresponding data to the register through one of the first and second data paths selected.

The performing step may instruct the information writing operation to write the first and second information into the first and second memories, respectively, in accordance with an access performed by the host computer and the executing step may instruct the information reading operation to start reading the first and second information from the first and second memories, respectively, upon a time the information writing operation starts writing the first and second information into the first and second memories, respectively. In this case, the method may further include the steps of detecting, outputting, and controlling. The detecting step detects memory statuses of the first-in and first-out memories included in the respective first and second memories, using the control circuit. The outputting step outputs a status signal representing the memory statuses detected. The controlling step controls the selecting step by the control circuit in accordance with a status as to whether the operation mode of the apparatus is the low power consumption mode and the status signal output from the status detecting circuit block.

The register, the first and second memories, and the control circuit may be integrated into a single integrated chip.

The patent specification further describes a novel optical disk drive apparatus which includes an optical disk drive mechanism and an interface circuit. The interface circuit for interfacing communications between the optical disk drive mechanism and a host computer includes an input terminal, a data processor, a clock generator, an operation mode changer, a buffering circuit block, and a path selection controller. The input terminal receives data sent from the host computer. The data processor is configured to perform a predetermined data processing operation to the data received through the input terminal. The clock generator is configured to generate a clock signal with which the data processor performs the predetermined data processing operation. The operation mode changer is configured to control the clock generator to reduce a frequency of the clock signal to a value smaller than a predetermined value to change an operation mode from a regular operation mode to a low power consumption mode. The buffering circuit block is configured to buffer the data received through the input terminal. The buffering circuit block includes a first data transfer path configured to transfer the data received through the input terminal to the data processor not via a memory and a second data transfer path configured to transfer the data received through the input terminal to the data processor via a memory. The path selection controller is configured to control the buffering circuit clock to select the second data transfer path on an exclusive basis when the operation mode is changed from the regular operation mode to the low power consumption mode.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a data processing system including an optical disk drive apparatus according to a preferred embodiment;

FIG. 2 is a schematic block diagram of an optical communications interface of the optical disk drive apparatus of FIG. 1;

FIG. 3 is a time chart for explaining an outline of timing for a data writing operation performed by the optical communications interface of FIG. 2;

FIG. 4 is a table showing a list of registers included in an ATA/ATAPI register circuit of the optical communications interface of FIG. 2;

FIG. 5 is a schematic block diagram for explaining details of operations performed by the ATA/ATAPI register circuit, an ATAPI controller, and a first-in and first-out memory of the optical communications interface of FIG. 2;

FIG. 6 is a time chart for explaining relationships among signals including a power saving signal PS, a memory empty signal Se, and a selection control signal FIFOSEL;

FIG. 7 is a time chart for explaining the data writing operation and a data reading operation performed by the optical communications interface of FIG. 2;

FIGS. 8 and 9 are illustrations for explaining a race between the writing and reading operations which brings memory empty and full statuses;

FIG. 10 is a flowchart for explaining an exemplary procedure of the data writing operation performed by the optical communications interface of FIG. 2; and

FIG. 11 is a flowchart for explaining an exemplary procedure of the data reading operation performed by the optical communications interface of FIG. 2.

### DETAILED DESCRIPTION OF PREFERRED EMBODIMENTS

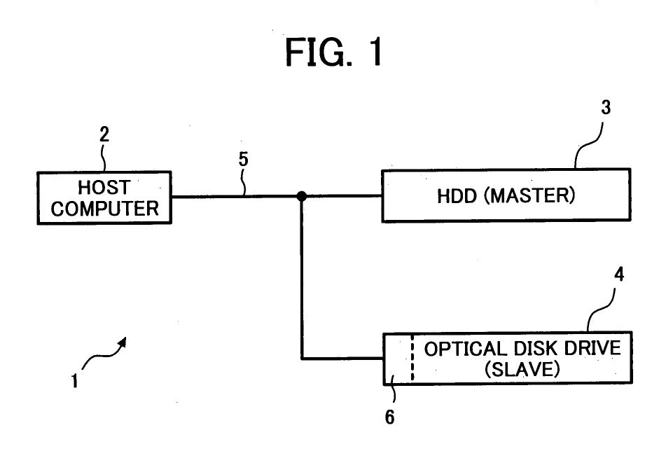

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. Referring now to the drawings, wherein like reference numerals designate identical or corresponding parts throughout the several views, an exemplary data processing system 1 including an interface circuit according to an exemplary embodiment is explained with reference to FIG. 1. As shown in FIG. 1, the data processing system 1 includes a host computer 2, a HDD (hard disk drive) unit 3, an optical disk drive unit 4, and a data bus 5. The host computer 2 communicates with the HDD unit 3 and the optical disk drive unit 4 through the data bus 5, using a specific interface such as an ATA/ATAPI standard (i.e., a unified standard based on AT attachment and AT attachment packet interface), for example, for a data transfer.

The data processing system 1 of FIG. 1 employs the ATA/ATAPI standard for a data transfer. For an ATA/ATAPI connection, each of the host computer 2, the HDD unit 3, and the optical disk drive unit 4 are provided with an interface circuit conforming to the ATA/ATAPI standard. For example, as shown in FIG. 1, an ATA/ATAPI compatible interface circuit 6 according to an exemplary embodiment is installed in the optical disk drive unit 4. Similar ATA/ATAPI compatible interface circuits are also installed in the host computer 2 and the HDD unit 3, although they are not shown in FIG. 1.

Generally, with the ATA/ATAPI connection, the ATA/ATAPI compatible interface circuit installed in the host computer 2 is capable of being coupled to two ATA/ATAPI compatible apparatuses, that is, two apparatuses having ATA/ATAPI compatible interface circuits.

In this data processing system 1 of FIG. 1, the HDD unit 3 having the ATA/ATAPI compatible interface circuit (not shown) is assigned as a master ATA/ATAPI compatible device (referred to as a master device), and the optical disk drive unit 4 having the ATA/ATAPI compatible interface circuit 6 is assigned as a slave ATA/ATAPI compatible device (referred to as a slave device). In addition, the data bus 5 connecting these ATA/ATAPI compatible apparatuses to the host computer 2 is also needed to be ATA/ATAPI compatible to properly achieve the ATA/ATAPI connection.

In the above-mentioned structure, the host computer 2 may be referred to as a host apparatus, and the HDD unit 3 and the optical disk drive unit 4 referred to as devices.

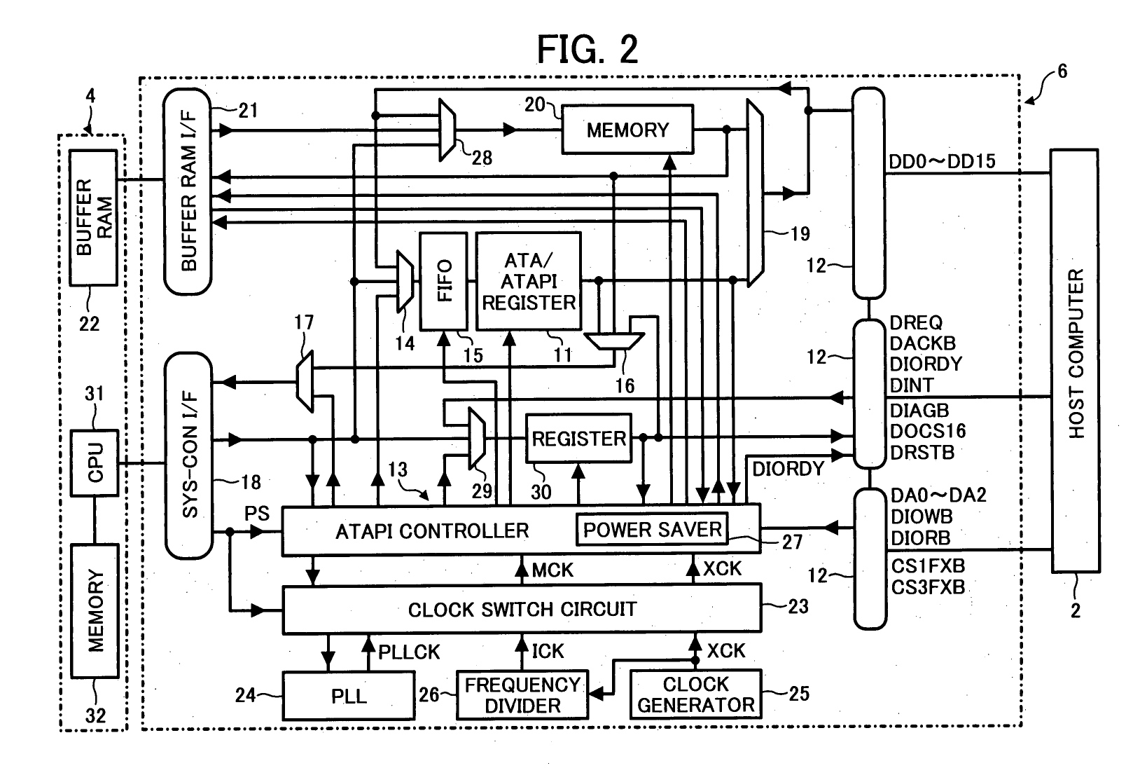

More details of the ATA/ATAPI compatible interface circuit 6 are explained with reference to FIG. 2. As shown in FIG. 2, the ATA/ATAPI compatible interface circuit 6 includes an ATA/ATAPI register 11, three connection terminals 12, an ATAPI controller 13, a selector 14, a FIFO (first-in and first-out) circuit 15, selectors 16 and 17, a system configuration (sys-con) interface 18, a selector 19, and a memory 20. The ATA/ATAPI compatible interface circuit 6 further includes a buffer RAM (read only memory) interface 21, a clock switch circuit 23, a PLL (phase-locked loop) circuit 24, a clock generator 25, a frequency divider 26, selectors 28 and 29, and a register 30.

In FIG. 2, reference numeral 22 denotes a buffer RAM (read only memory), reference numeral 31 denotes a CPU (central processing unit), and reference numeral 32 denotes a memory, which are included in the optical disk drive unit 4.

In the ATA/ATAPI compatible interface circuit 6 of FIG. 2, the ATA/ATAPI register 11 is a register memory from or to which data for a data read and write operation is transmitted to or received from the host computer 2 via the connection terminals 12 which are ATA/ATAPI compatible. The ATA/ATAPI register 11 is controlled by the ATAPI controller 13 so that the data from the host computer 2 is written into the ATA/ATAPI register 11 via the selector 14 and the FIFO circuit 15. The data written into the ATA/ATAPI register 11 are transferred to the CPU 31 of the optical disk drive unit 4 via the selectors 16 and 17 and the sys-con interface 18.

Also, the data from the CPU 31 is written into the ATA/ATAPI register 11 via the sys-con interface 18, the selector 14, and the FIFO circuit 15. The data written into the ATA/ATAPI register 11 is transferred to the host computer 2 via the selector 19 and the connection terminal 12. The selectors 14, 16, 17, and 19 are controlled by the ATAPI controller 13. In FIG. 2, connections for the ATAPI controller 13 to control the selectors 16 and 19 are not shown.

The memory 32 of the optical disk drive unit 4 stores a control program for the CPU 31 to read and perform data transmission using the APA/ATAPI compatible interface circuit 6. In order to perform data transmission with the host computer 2, the APA/ATAPI compatible interface circuit 6 interfaces the data transmission between the connection terminal 12 and the buffer RAM-interface 21 by using the memory 20. The buffer RAM interface 21 is connected to the buffer RAM 22 which includes DRAMs (dynamic random access memories) to store data to be written into an optical disk or read from an optical disk.

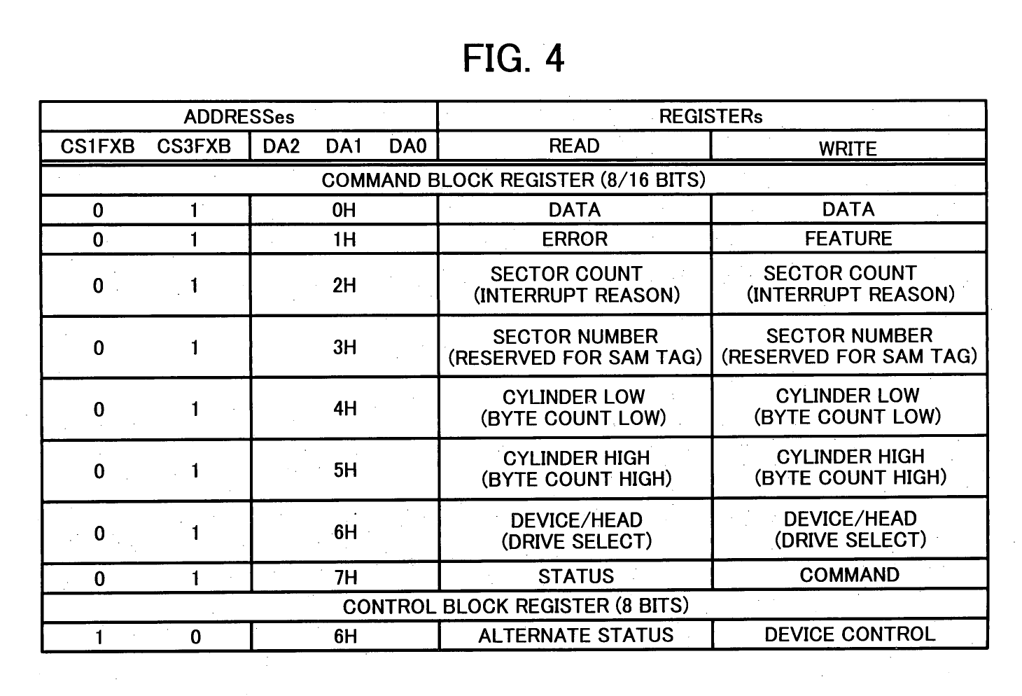

The ATAPI controller 13 receives inputs of address data DA[2:0], a write control signal DIOWB, a read control signal DIORB, and chip select signals CS1FXB and CS3FXB from the host computer 2 via the connection terminal 12. The address data DA[2:0] represents an address of the ATA/ATAPI register 11. The write control signal DIOWB is a signal for controlling a process for writing data to the ATA/ATAPI register 11. The read control signal DIORB is a signal for controlling a process for reading data from the ATA/ATAPI register 11. The chip select signals CS1FXB and CS3FXB are signals for selecting one of command and control block registers (see FIG. 4) included in the ATA/ATAPI register 11.

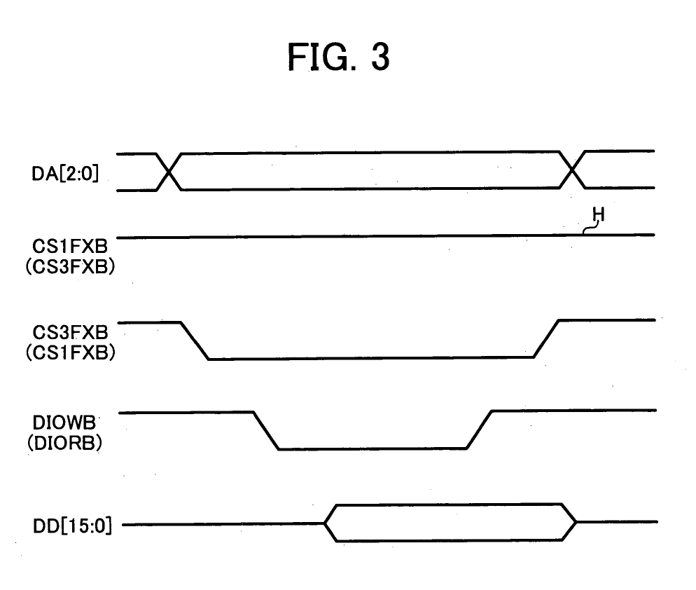

FIG. 3 shows a time chart of an event in which the host computer 2 accesses the ATA/ATAPI register 11 to write data thereto via the connection terminal 12. When the host computer 2 accesses the ATA/ATAPI register 11 to read data therefrom, the write control signal DIOWB of FIG. 3 is substituted by the read control signal DIORB.

The ATA/ATAPI register 11 is a register equivalent to an ATA/ATAPI register redefined after the unification of the ATA and ATAPI standards which is based on enhancement of the register peculiar to the hard disk drive compatible with the standard ATA to become compatible with a register for a CD-ROM (compact disc read only memory) apparatus conformable to the ATAPI standard.

As shown in FIG. 4, the ATA/ATAPI register 11 includes nine registers designated by the chip select signals CS1FXB and CS3FXB and the address data DA[2:0]. In FIG. 4, a first listed register of the nine registers designated by the chip select signals CS1FXB and CS3FXB of 0 and 1, respectively, and the address data DA[2:0] of 0H registers data in both read and write modes. A second listed register of the nine registers designated by the chip select signals CS1FXB and CS3FXB of 0 and 1, respectively, and the address data DA[2:0] of 1H registers error information in the read mode and feature information in the write mode. A third listed register of the nine registers designated by the chip select signals CS1FXB and CS3FXB of 0 and 1, respectively, and the address data DA[2:0] of 2H registers information of a sector count in both read and write modes. A fourth listed register of the nine registers designated by the chip select signals CS1FXB and CS3FXB of 0 and 1, respectively, and the address data DA[2:0] of 3H registers information of a sector number in both read and write modes. A fifth listed register of the nine registers designated by the chip select signals CS1FXB and CS3FXB of 0 and 1, respectively, and the address data DA[2:0] of 4H registers information of a cylinder low in both read and write modes. A sixth listed register of the nine registers designated by the chip select signals CS1FXB and CS3FXB of 0 and 1, respectively, and the address data DA[2:0] of 5H registers information of a cylinder high in both read and write modes. A seventh listed register of the nine registers designated by the chip select signals CS1FXB and CS3FXB of 0 and 1, respectively, and the address data DA[2:0] of 6H registers information of a device/head in both read and write modes. An eighth listed register of the nine registers designated by the chip select signals CS1FXB and CS3FXB of 0 and 1, respectively, and the address data DA[2:0] of 7H registers status information in the read mode and command information in the write mode. A ninth listed register of the nine registers designated by the chip select signals CS1FXB and CS3FXB of 1 and 0, respectively, and the address data DA[2:0] of 6H registers information of an alternate status in the read mode and information of device control in the write mode. In FIG. 4, terms indicated in brackets in the columns of the information to be registered represent corresponding ATTAPI register names.

The host computer 2 can select one of the master and slave devices to use by presetting of a predefined bit of the seventh listed register to 1 or 0. For example, when the hard disk drive unit 3 is connected as the master device and the optical disk drive unit 4 is connected as the slave device, as so indicated in FIG. 1, the host computer 2 correctly registers these connections to the seventh listed register which is the device/head register, or the drive select register so as to correctly recognize whether the access is to the master or the slave. When the host computer 2 writes data to this drive select register, the data are written into the drive select register of both master and slave devices. In this case, the host computer 2 can select the master device by first setting a DRV bit (referred to as a fourth bit) of the drive select register to 0 to write data into the master device and then by setting the DRV bit to 1 to write data into the slave device.

The connections of the hard disk drive unit 3 and the optical disk drive unit 4 as the master device or slave device are determined when the hard disk drive unit 3 and the optical disk drive unit 4 are installed to the host computer 2. Therefore, each of the master and slave devices can recognize whether it is selected or not by comparing a value determined at the installation with a value then set by the host computer 2. For example, the optical disk drive unit 4 when connected as a slave device is switched into a low power consumption mode when the host computer 2 selects the master device and is returned to a regular power consumption mode from low power consumption mode when the host computer 2 selects the slave device. In low power consumption mode, the optical disk drive unit 4 consumes a relatively small power by being applied with a clock signal having a frequency smaller than that of the clock signal used in regular power consumption mode.

In FIG. 2, when the operation mode is switched to low power consumption mode, the CPU 31 of the optical disk drive unit 4 instructs the sys-con interface 18 to enable a power saving signal PS transmitted to the ATAPI controller 13 and the clock switch circuit 23. The clock switch circuit 23 is connected to the PLL circuit 24, the clock generator 25, and the frequency divider 26. The PLL circuit 24 generates a predetermined clock signal PLLCK. The clock circuit 25 generates a predetermined clock signal XCK using a crystal oscillator. The frequency divider 26 generates a plurality of clock signals having different frequencies and outputs one of the plurality of clock signals previously selected as a clock signal ICK. The clock signal PLLCK has a frequency higher than that of the clock signal XCK and needs a relatively longer time to become stable. The clock signal ICK has a frequency lower than those of the clock signals PLLCK and XCK.

The clock signals generated by the frequency divider 26 have frequencies of 1 MHz, 2 MHz, 4 MHz, and 8 MHz, for example. The clock signal having a frequency of 1 MHz is output as the clock signal ICK to the clock switch circuit 23. The clock switch circuit 23 determines that the current operation mode is regular operation mode when the power saving signal PS is in a disabled state and outputs the clock signal PLLCK from the PLL circuit 24 as a main clock signal MCK to the ATAPI controller 13. At the same time the clock switch circuit 23 outputs the clock signal XCK from the clock generator 25 to the ATAPI controller 13.

When the power saving signal PS is in an enabled state, the clock switch circuit 23 stops the operations of the PLL circuit 24 in accordance with the instructions from the ATAPI controller 13. At the same time, the clock switch circuit 23 determines that the operation mode is low power consumption mode and outputs the clock signal ICK as the main clock signal MCK to the ATAPI controller 13. In this case, the clock switch circuit 23 also outputs the clock signal XCK to the ATAPI controller 13.

When the power saving signal PS becomes disabled, the clock switch circuit 23 activates the PLL circuit 24 in accordance with the instructions sent from the ATAPI controller 13. The PLL circuit 24, however, takes a certain time period to stably generate the clock signal PLLCK and therefore the clock switch circuit 23, at the same time, outputs the clock signal XCK as the main clock signal MCK to the ATAPI controller 13 for a predetermined time period in which the PLL circuit 24 stably generates the clock signal PLLCK. After the predetermined time period, the clock switch circuit 23 outputs the clock signal PLLCK of the PLL circuit 24 to the ATAPI controller 13.

The transition of the operation mode from low power consumption mode to regular operation mode is conducted with a control signal sent from the host computer 2. That is, when one of the write control signal DIOWB and the read control signal DIORB is asserted by the host computer 2, the ATAPI controller 13 notifies the assertion to the CPU 31 and subsequently the sys-con interface 18 disables the power saving signal PS. The ATAPI controller 13 includes a power saver 27 which detects the write control signal DIOWB and the read control signal DIORB and notifies the change from low power consumption mode to regular operation mode to the CPU 31.

As described above, upon the selection of an ATA/ATAPI device to be controlled by changing the value of the seventh listed register which is the device/head register, or the drive select register, the host computer 2 changes the value of the ATA/ATAPI register 11 of the ATA/ATAPI device selected. For example, when the main clock signal MCK is set to 1 MHz in the low power consumption mode and the host computer 2 changes the value of the drive select register (i.e., DRV=1), the operation mode is returned from low power consumption mode to regular operation mode and the clock signal XCK is used as the main clock signal MCK.

At this time, the value change of the ATA/ATAPI register 11 can be made in an asynchronous manner. With such an asynchronous way, it becomes possible to reduce the frequency of the clock signal in low power consumption mode. However, the ATA/ATAPI register 11 may becomes weak against external noises so that the ATA/ATAPI register 11 may erroneously changes its register value due to the external noises. In order to make the ATA/ATAPI register 11 stronger against external noises, writing operation to the ATA/ATAPI register 11 at mode transition from low power consumption mode to regular operation mode is synchronized with the main clock signal MCK. In this case, when writing operations are continuously conducted relative to a plurality of registers, time intervals between the writing operations may become shorter and an error may be caused in which the data is written at an incorrect address, for example.

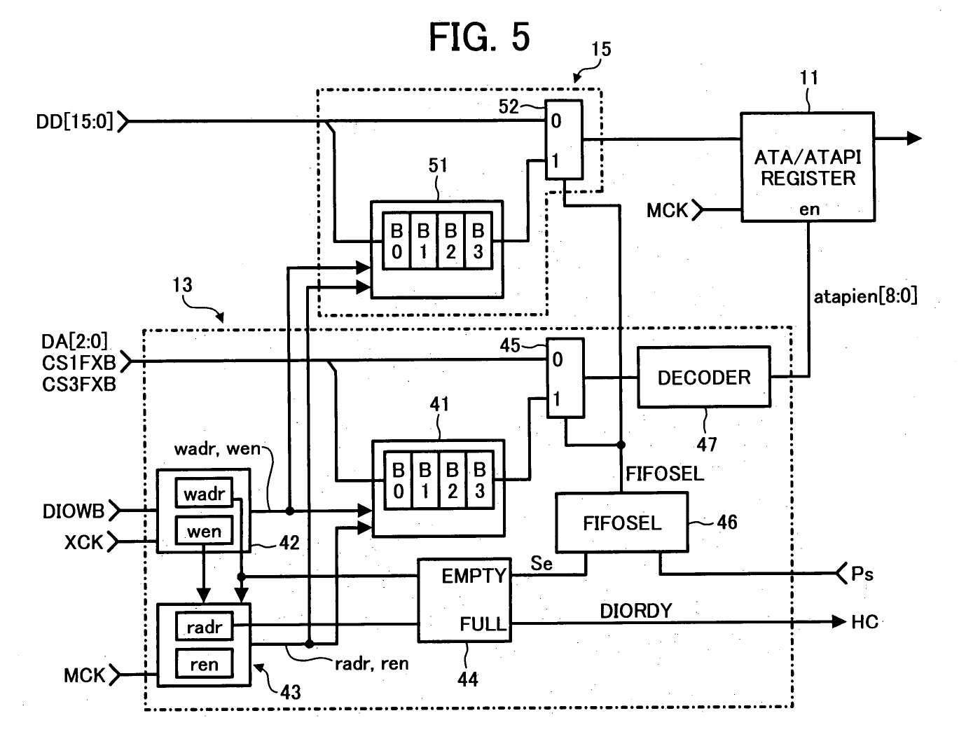

To avoid the above-mentioned error, writing operation is multiplexed. For example, a first FIFO memory 41 (see FIG. 5) assigned as a memory for storing address data is provided to the ATAPI controller 13, and a second FIFO memory 51 (see FIG. 5) assigned as a memory for storing data is provided to the FIFO circuit 15. The ATAPI controller 13 stores address data indicated by the ATA/ATAPI register 11 to the first FIFO memory 41 and stores data to be written to an address represented by the address data indicated by the ATA/ATAPI register 11 to the second FIFO memory 51.

FIG. 5 shows inside blocks of the ATAPI controller 13 and the FIFO circuit 15. As shown in FIG. 5, the ATAPI controller 13 includes the first FIFO memory 41, a write control circuit 42, and a read control circuit 43. The write control circuit 42 controls write operations to the first FIFO memory 41 write operations and to the second FIFO memory 51, and the read control circuit 43 controls read operations to the first FIFO memory 41 and read operations to the second FIFO memory 51.

The ATAPI controller 13 further includes a status detector 44, a selector 45, a control signal generator 46, and a decoder 47. The detector 44 detects various statuses of the first FIFO memory 41 and the second FIFO memory 51. The control signal generator 46 generates a selection control signal FIFOSEL for controlling the selector 45. The decoder 47 decodes the address data DA[2:0] and the chip select signals CS1FXB and CS3FXB into the address of the ATA/ATAPI register 11.

In FIG. 5, the FIFO circuit 15 includes the second FIFO memory 51 and a selector 52.

In the ATAPI controller 13, the address data DA[2:0] and the chip select signals CS1FXB and CS3FXB are input to the first FIFO memory 41 and to one input terminal of the selector 45. The first FIFO memory 41 outputs a data signal to the other input terminal of the selector 45. A data signal output from the selector 45 is decoded by the decoder 47 into 9-bit address data signal atapien[8:0] representing a desired register of the ATA/ATAPI register 11. The address data signal atapien[8:0] is input to the ATA/ATAPI register 11. Upon receiving the address data signal atapien[8:0], the ATA/ATAPI register 11 is enabled. The selector 45 selects one of the two input signals in accordance with the selection control signal FIFOSEL sent from the control signal generator 46, and exclusively outputs the selected signal.

The write control circuit 42 receives the write control signal DIOWB sent from the host computer 2 via one of the connection terminals 12 and the clock signal XCK. The write control circuit 42 generates write address signal wadr and write enable signal wen for controlling the first FIFO memory 41 and the second FIFO memory 51. The write address signal wdr and write enable signal wen are transmitted to the first and second FIFO memories 41 and 51 and the read control circuit 43. In addition, the write address signal wdr is also sent to the status detector 44.

The read control circuit 43 receives the main clock signal MCK and generates a read address signal radr and a read enable signal ren based on the write address signal wadr and the write enable signal wen input from the write control circuit 42. The read address signal radr and the read enable signal ren are input to the first and second FIFO memories 41 and 51. The read address signal radr is also sent to the status detector 44.

The status detector 44 detects a memory empty status and a memory full status based on the write address signal wadr and the read address signal radr. The memory empty status represents a status in which the first and second FIFO memories store no data. The memory full status represents a status in which the first and second FIFO memories fully store data. The status detector 44 sends a memory empty signal Se indicative of the memory empty status to the control signal generator 46 and a memory full signal DIORDY indicative of the memory full status to the host computer 2 via one of the connection terminals 12.

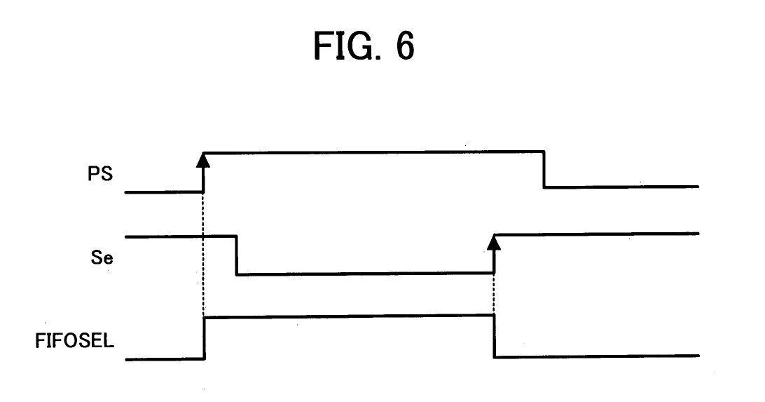

The control signal generator 46 also receives the power saving signal PS and generates the selection control signal FIFOSEL based on the power saving signal PS and the memory empty signal Se, as shown in FIG. 6. The selection control signal FIFOSEL generated is sent to the selectors 45 and 52. More specifically, as shown in FIG. 6, when the power saving signal PS is raised from a low level to a high level so that the operation mode is turned into low power consumption mode, the selection control signal FIFOSEL is raised from a low level to a high level. Accordingly, the selector 45 selects and outputs data from the first FIFO memory 41, and the selector 52 selects and outputs data from the second memory 51.

When the memory empty signal is raised from a low level to a high level, the selection control signal FIFOSEL falls from the high level to the low level. Accordingly, the selector 45 selects and outputs the address data DA[2:0] and the chip select signals CS1FXB and CS3FXB, and the selector 52 selects and outputs 16-bit input data DD[15:0] which are sent from the host computer 2 via the connection terminal 12 and the selector 14.

In the FIFO circuit 15, the data DD[15:0] are input to the second FIFO memory 51 and one of two input terminals of the selector 52, and a data signal output from the second FIFO memory 51 is transmitted to the other one of the two input terminals of the selector 52. A data signal output from the selector 52 is sent to and stored in the ATA/ATAPI register 11. The selector 52 selects one of the two input data signals in accordance with the selection control signal FIFOSEL input from the control signal generator 46, and exclusively outputs the selected data signal. In addition, the ATA/ATAPI register 11 is provided with an input of the main clock signal MCK.

The ATA/ATAPI register 11 may be referred to as a register circuit. The first FIFO memory 41 and the selector 45 may be regarded as one circuitry block and referred to as a first storing circuit. The FIFO circuit 15 may be referred to as a second storing circuit. The write control circuit 42, the read control circuit 43, the status detector 44, and the control signal generator 46 may be regarded as one circuitry block and referred to as a control circuit. Each of the selectors 45 and 52 may be referred to as a selecting circuit, and control signal generator 46 itself may be referred to as a selection control circuit. The ATA/ATAPI register 11 may be referred to as a data processing circuit. The PLL circuit 24, the clock generator 25, and the frequency divider 26 may be regarded as one circuitry block and referred to as a clock signal generator. The clock switch circuit 23 may be referred to as an operation mode changer. The FIFO circuit 15 may be referred to as a buffer circuit, and the ATA/ATAPI controller 13 as a signal path changer. In a strict sense, the first FIFO memory 41 and the selector 45, which may be regarded as one circuitry block and referred to as a first storing circuit, as described above, may be regarded as another buffer circuit.

The above-mentioned register circuit, the first and second storing circuits, and the control circuit may be packed into a single integrated chip.

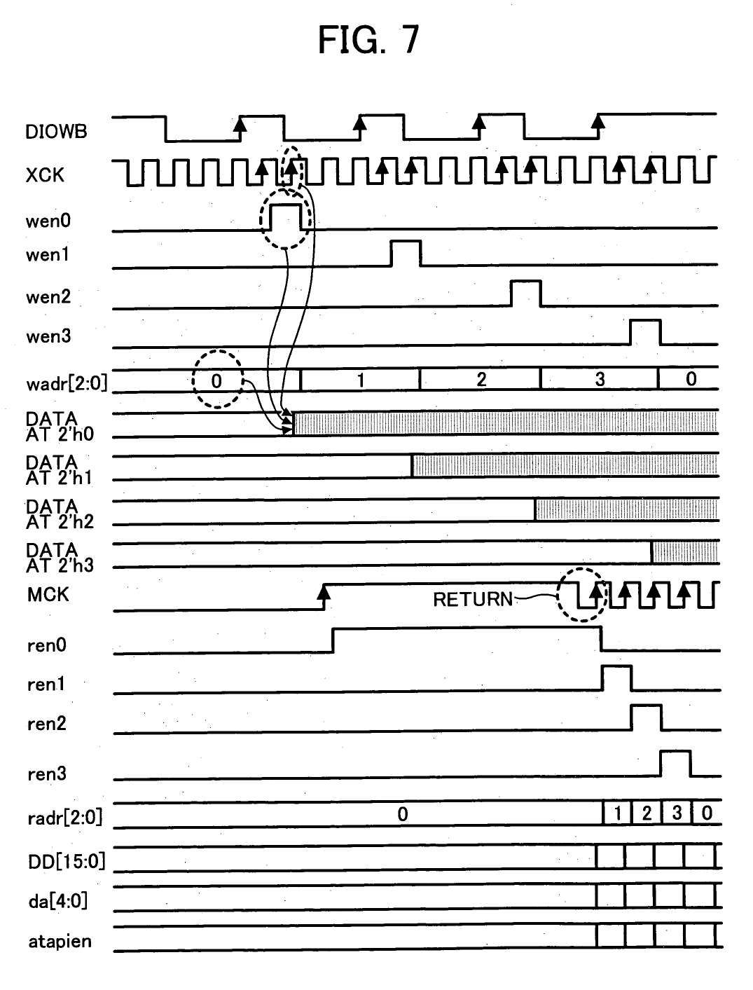

Referring to FIG. 7, exemplary operations of the data processing system 1 having the above-described structure are explained. An exemplary data writing operation is discussed in this section, for writing data to the ATA/ATAPI register 11 through a buffering process using the first and second FIFO memories 41 and 51 when the mode is changed from low power consumption mode to regular operation mode. In the example of FIG. 2, each of the first and second FIFO memories 41 and 51 is provided with four buffer areas B0-B3, as shown in FIG. 5. Accordingly, in FIG. 7, the write enable signal wen is represented by wen0-wen3 forming four-bit data, and the read enable signal ren is represented by ren0-ren3 forming four-bit data.

In FIG. 7, the write address wadr[2:0] indicates numerical FIGS. 0-3 which represent the addresses of the buffer areas B0-B3 of the first and second FIFO memories 41 and 51 and the read address radr[2:0] indicates likewise numerical FIGS. 0-3 representing the addresses of the buffer areas B0-B3. FIG. 7 also indicates data da[4:0] represents 5-bit data including the 3-bit data of the address data DA[2:0] and the 2-bit data of the chip select signals CS1FXB and CS3FXB. Further, FIG. 7 also indicates data at addresses 2′h0-2′h3.

When the power saving signal PS is raised to the high level and accordingly the operation mode enters into low power consumption mode, the control signal generator 46 outputs the selection control signal FIFOSEL at the high level. Then, the write control signal DIOWB from the host computer 2 falls and is asserted. After that, at the rising edge of the control signal DIOWB, the write address wadr[2:0] and the write enable signals wen0-wen3 are generated in synchronism with the clock signal XCK. In other words, the write control circuit 42 generates in a sequential order the write enable signals wen0-wen3, which allow data to be written into the first and second FIFO memories 41 and 51, in synchronism with respective subsequent rising edges of the clock signal XCK after the rise of the write control signal DIOWB to the high level. The write enable signal wen0-wen3 generated are transmitted to the first and second FIFO memories 41 and 51.

Subsequently, the data DD[15:0] is written into the first FIFO memory 41 at the address designated by the write address wadr[2:0]. At the same time, the address data DA[2:0] and the chip select signal CS1FXB and the CS3FXB are written into the second FIFO memory 51 at the address designated by the write address wadr[2:0]. The read control circuit 43 receives the write address wadr[2:0] and the write enable signals wen0-wen3 from the write control circuit 42, and generates the read address radr[2:0] and the read enable signals ren0-ren3 in synchronism with the main clock signal MCK. The read address radr[2:0] and the read enable signals ren0-ren3 generated are transmitted to the first and second FIFO memories 41 and 51.

That is, the read control circuit 43 reads in a sequential order the data DD[15:0] written in the first FIFO memory 41 and the address data DA[2:0] and the chip select signals CS1FXB and CS3FXB written in the second FIFO memory 51 in synchronism with the read enable signals ren0-ren3 respectively triggered by subsequent rising edges of the main clock signal MCK after the respective write enable signals wen0-wen3. The address data DA[2:0] and the chip select signals CS1FXB and CS3FXB are decoded into the address data signal atapien[8:0] and are written into the ATA/ATAPI register 11 in synchronism with the main clock signal MCK. Since the ATA/ATAPI register 11 includes nine registers, as described above, the address data signal atapien which serves also as the enable signal is arranged as a 9-bit signal.

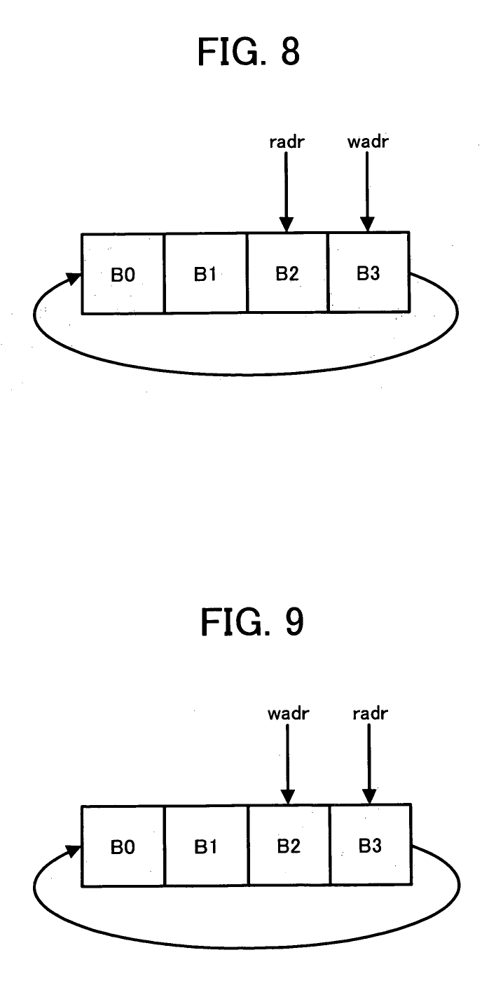

In the first and second FIFO memories 41 and 51, assertion of the write address wadr precedes that of the read address radr. In a case the data writing to the FIFO memories takes a relatively long time period and the data reading from the FIFO memories is performed in a relatively short time period, for example, the data reading may overtake the process of the data writing, as shown in FIG. 8, resulting in an event in which the FIFO memories turn into the memory empty status. In this case, the status detector 44 detects the memory empty status and accordingly outputs the memory empty signal Se at the high level, which indicates a detection of the memory empty status with respect to the FIFO memories. Therefore, the control signal generator 46 outputs the selection control signal FIFOSEL at the low level so that the data DD[15:0] is sent to the ATA/ATAPI register 11 and also the address data DA[2:0] and the chip select signals CS1FXB and CS3FXB decoded by the decoder 47 are sent to the ATA/ATAPI register 11. The status decoder 44 determines the status of the FIFO memories as being empty when the values of the write address ward[2:0] and the read address radr[2:0] are equal to each other, that is, an equation [wadr−radr=1] is satisfied.

In another case where the data writing to the FIFO memories takes a relatively short time period while the data reading takes a relatively long time period, the data writing may overtake the process of the data reading, as shown in FIG. 9, resulting in an event in which the FIFO memories turn into the full status. In this case, the status detector 44 detects the memory full status and accordingly outputs the memory full signal DIORDY at the high level, which indicates a detection of the memory full status with respect to the FIFO memories. The memory full signal DIORDY is sent to the host computer 2 via the connection terminal 12 so as to tentatively stop the host computer 2 to access the optical disk drive unit 4.

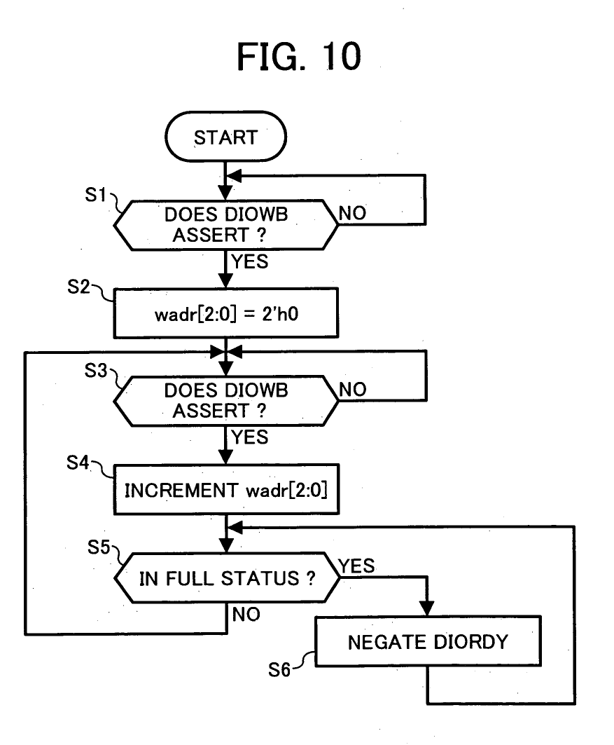

Referring to FIG. 10, an exemplary procedure is explained, for data writing to the first and second FIFO memories 41 and 51 when the operation mode is changed from low power consumption mode to regular operation mode. In Step S1 of FIG. 10, the write control circuit 42 determines whether the write control signal DIOWB from the host computer 2 is asserted. When the write control signal DIOWB is determined as being asserted and the determination result of Step S1 is YES, the write control circuit 42 assigns the data at the address 2′h0 to the write address wadr[2:0] and outputs the data-assigned write address wadr[2:0] to the first and second FIFO memories 41 and 51, in Step S2. That is, in Step S2, the write enable signal wen0 is raised to the high level and data is written at a first address of each of the first and second FIFO memories 41 and 51. When the write control signal DIOWB is determined as not being asserted and the determination result of Step S1 is NO, the write control circuit 42 repeats the determination process of Step S1.

Then, in Step S3, the write control circuit 42 determines whether a subsequent input of the write control signal DIOWB from the host computer 2 is asserted. When the subsequent input of the write control signal DIOWB from the host computer 2 is determined as being asserted and the determination result of Step S3 is YES, the write control circuit 42 increments the write address wadr[2:0] by one, in Step S4. In other words, in Step S4, the data writing is conducted with respect to the subsequent addresses of the first and second FIFO memories 41 and 51. When the subsequent input of the write control signal DIOWB from the host computer 2 is determined as not being asserted and the determination result of Step S3 is NO, the write control circuit 42 repeats the determination process of Step S3.

Then, in Step S5, the status detector 44 determines whether the first and second FIFO memories 41 and 51 are in the memory full status. When the first and second FIFO memories 41 and 51 are determined as being in the memory full status and the determination result of Step S5 is YES, the status detector 44 negates the memory full signal DIORDY to the low level, in Step S6, and repeats the determination process of Step S5. When the first and second FIFO memories 41 and 51 are determined as not being in the memory full status and the determination result of Step S5 is NO, the status detector 44 repeats the determination process of Step S3.

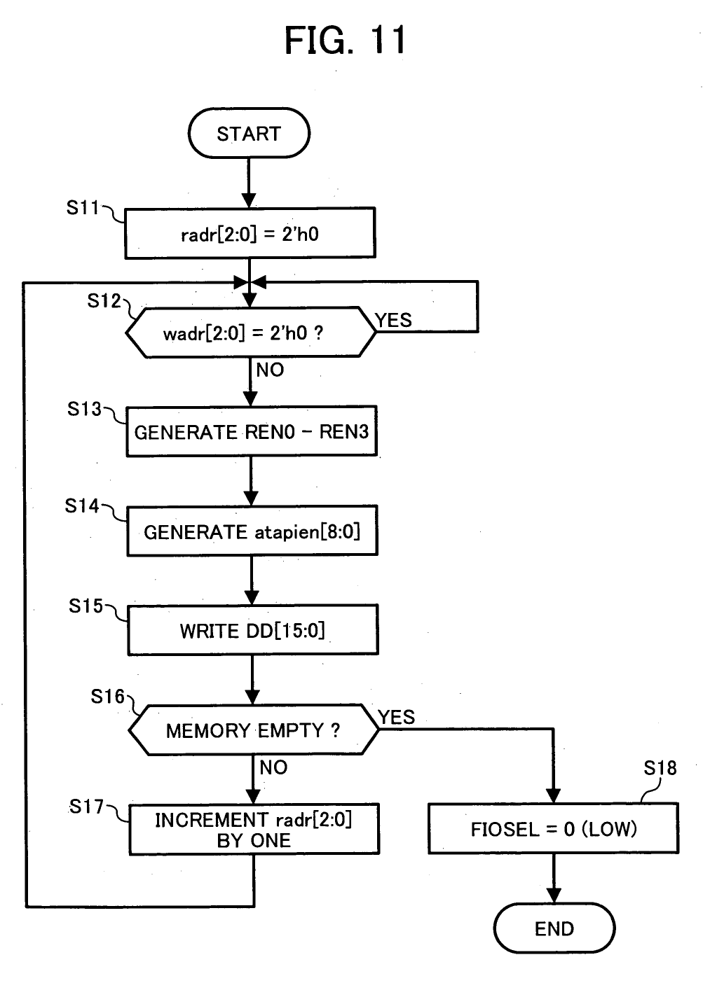

Referring to FIG. 11, an exemplary procedure is explained, for the data reading from the first and second FIFO memories 41 and 51 when the operation mode is changed from low power consumption mode to regular operation mode. In FIG. 11, the read control circuit 43 sets the read address radr[2:0] to the data at the address 2′h0, in Step S11, and determines whether the write address wadr[2:0] is equal to the value of the data at the address 2′h0, in Step S12.

When the write address wadr[2:0] is determined as not being equal to the value of the data at the address 2′h0 and the determination result of Step S12 is NO, the read control circuit 43 generates the read enable signals ren0-ren3 based on the read address radr[2:0] and outputs the read enable signals ren0-ren3 generated to the first and second FIFO memories 41 and 51, in Step S13. That is, in Step S13, the data at the read address radr[2:0] having the value of the data at the address 2′h0 in the first and second FIFO memories 41 and 51 is read and transferred to the ATA/ATAPI register 11. When the write address wadr[2:0] is determined as being equal to the value of the data at the address 2′h0 and the determination result of Step S12 is YES, the read control circuit 43 repeats the determination process of Step S12.

In Step S14, the decoder 47 decodes the address data DA[2:0] and the chip select signals CS1FXB and CS3FXB, sent via the first FIFO memory 41, into the address data signal. atapien[8:0] and outputs the address data signal atapien[8:0] generated to the ATA/ATAPI register 11. Then, in Step S15, the ATA/ATAPI register 11 writes the data DD[15:0] input from the second FIFO memory 51 at the register addressed by the address data signal atapien[8:0].

After that, the status detector 44 determines in Step S16 whether the first and second FIFO memories 41 and 51 are in the memory empty status. When the first and second FIFO memories 41 and 51 are determined as not being in the memory empty status and the determination result of Step S16 is NO, the read control circuit 43 increments the read address radr[2:0] by one, in Step S17, and returns to the process of Step S12. When the first and second FIFO memories 41 and 51 are determined as being in the memory empty status and the determination result of Step S16 is YES, the status detector 44 sets the selection control signal FIFOSEL to the low level, in Step S18. Then, the process ends.

In this way, the interface circuit according to the above-described embodiment is configured to store the data indicating an address of a desired register of the ATA/ATAPI register 11 into the first FIFO memory 41 and the data to be written into the desired register of the ATA/ATAPI register 11 into the second FIFO memory 51 when the mode is changed from the low power consumption mode operating with the clock signal at a reduced frequency to the regular operation mode. This interface is further configured to write such data stored in the second FIFO memory 51 into a register of the ATA/ATAPI register 11 addressed by the data stored in the first FIFO memory 41. Therefore, the interface according to the present embodiment described above can process the accesses entered from the host computer 2 in a proper sequence without causing errors when the mode is changed from the low power consumption mode operating with the clock signal at a reduced frequency to the regular operation mode.

The above-described embodiment may be conveniently implemented using a conventional general purpose digital computer programmed according to the teachings of the present specification, as will be apparent to those skilled in the computer art. Appropriate software coding can readily be prepared by skilled programmers based on the teachings of the present disclosure, as will be apparent to those skilled in the software art. The above-described embodiment may also be implemented by the preparation of application specific integrated circuits or by interconnecting an appropriate network of conventional component circuits, as will be readily apparent to those skilled in the art.

Numerous additional modifications and variations are possible in light of the above teachings. It is therefore to be understood that within the scope of the appended claims, the disclosure of this patent specification may be practiced otherwise than as specifically described herein.

This patent specification is based on Japanese patent application, No. JPAP2003-072141 filed on Mar. 17, 2003 in the Japan Patent Office, the entire contents of which are incorporated by reference herein.

What is claimed is:

1. A communications interface apparatus, comprising:
a register circuit storing data to be transferred to a host computer;
a first memory storing first information indicating a specific address of the register circuit and representing an access to the communications interface apparatus executed by the host computer for a data transfer;
a second memory storing second information, sent from the host computer in association with the first information stored in the first memory, to be written into the register circuit at the specific address indicated by the first information stored in the first memory; and
a control circuit configured to perform an information writing operation for writing the first information into the first memory and the second information into the second memory in chronological order of accesses executed.

2. A communications interface apparatus according to claim 1, wherein the control circuit performs the information writing operation to write the first information into the first memory and the second information into the second memory in chronological order of accesses executed, when an operation mode of the communications interface apparatus is changed from a low power consumption mode to a regular operation mode.

3. A communications interface apparatus according to claim 2, wherein the control circuit performs an information reading operation for reading the first and second information written in the first and second memories, respectively, in chronological order of the accesses executed and an information transfer operation to transfer the first and second information read from the first and second memories, respectively, to the register circuit in chronological order of the accesses executed, when the operation mode of the communications interface apparatus is changed from the low power consumption mode to the regular operation mode.

4. A communications interface apparatus according to claim 3, wherein each of the first and second memories comprises a first-in and first-out memory including a specific number of buffer areas into which data from the host computer is written, and the control circuit conducts the information writing operations with respect to the first and second memories in synchronism with each other and conducts the information reading operations with respect to the first and second memories in synchronism with each other.

5. A communications interface apparatus according to claim 4, wherein the control circuit accesses the first and second memories in synchronism with a first clock signal for the information writing operation and a second clock signal for the information reading operation, and wherein a first frequency of the first clock signal is greater than a second frequency of the second clock signal.

6. A communications interface apparatus according to claim 5, wherein the control circuit transfers the first and second information directly to the register circuit, without buffering the first and second information in the first-in and first-out memories of the first and second memories, in an event that the respective first-in and first-out memories of the first and second memories are in a memory empty state after the first and second information stored in the respective first-in and first-out memories of the first and second memories, respectively, are transferred to the register circuit when the operation mode of the communications interface apparatus is changed from the low power consumption mode to the regular operation mode.

7. A communications interface apparatus according to claim 6, wherein each of the first and second memories comprises a selection circuit configured to select one of (i) a first data path for the first and second information not via the first and second memories and (ii) a second data path for the first and second information via the respective first and second memories, on-an exclusive basis according to a control signal from the control circuit and to output corresponding data to the register circuit through the selected one of the first and second data paths.

8. A communications interface apparatus according to claim 7, wherein the control circuit comprises:
a data writing circuit block configured to write the first and second information into the first and second memories, respectively, in accordance with an access performed by the host computer;
a data reading circuit block configured to start reading the first and second information from the first and second memories, respectively, upon a time the write control circuit block starts writing the first and second information into the first and second memories, respectively;
a status detecting circuit block configured to detect memory statuses of the first-in and first-out memories included in the respective first and second memories and to output a status signal representing the memory statuses detected; and
a selection control circuit block configured to control the selection circuits included in the respective first and second memories in accordance with a status as to whether the operation mode of the communications interface apparatus is the low power consumption mode and the status signal output from the status detecting circuit block.

9. A communications interface apparatus according to claim 1, wherein the register circuit, the first and second memories, and the control circuit are integrated into a single integrated chip.

10. A communications interfacing method comprising the steps of:
storing in a register circuit data to be transferred to a host computer;
storing in a first memory first information indicating a specific address of the register circuit and representing an access to a communications interface apparatus executed by the host computer for a data transfer, and storing in a second memory second information, sent from the host computer in association with the first information stored in the first memory, to be written into the register circuit at the specific address indicated by the first information stored in the first memory; and
performing an information writing operation with a control circuit for writing the first information into the first memory and the second information into the second memory in chronological order of accesses executed.

11. A communications interfacing method according to claim 10, wherein the performing step performs the information writing operation to write the first information into the first memory and the second information into the second memory in chronological order of accesses executed, when an operation mode of the communications interface apparatus is changed from a low power consumption mode to a regular operation mode.

12. A communications interfacing method according to claim 11, further comprising the steps of:
executing an information reading operation with the control circuit for reading the first and second information written in the first and second memories, respectively, in chronological order of the accesses executed by the performing step; and
conducting an information transfer operation with the control circuit for transferring the first and second information read from the first and second memories, respectively, performed by the executing step to the register circuit in chronological order of the accesses executed, when the operation mode of the communications interface apparatus is changed from the low power consumption mode to the regular operation mode.

13. A communications interfacing method according to claim 12, wherein each of the first and second memories includes a first-in and first-out memory including a specific number of buffer areas into which data from the host computer is written by the performing step, and
wherein the performing step performs the information writing operations with respect to the first and second memories in synchronism with each other and the executing step executes the information reading operations with respect to the first and second memories in synchronism with each other.

14. A communications interfacing method according to claim 13, wherein the performing step uses a first clock signal for synchronizing the information writing operation and the executing step uses a second clock signal for synchronizing the information reading operation, and
wherein a first frequency of the first clock signal is greater than a second frequency of the second clock signal.

15. A communications interfacing method according to claim 14, wherein the data writing operation performed by the performing step transfers the first and second information directly to the register circuit without buffering the first and second information into the first-in and first-out memories of the first and second memories, in an event that the respective first-in and first-out memories of the first and second memories are in a memory empty state after the first and second information written in the respective first-in and first-out memories of the first and second memories, respectively, are transferred to the register circuit when the operation mode of the communications interface apparatus is changed from the low power consumption mode to the regular operation mode.

16. A communications interfacing method according to claim 15, further comprising the steps of:
generating a selection control signal using the control circuit;
selecting one of (i) a first data path for the first and second information not via the first and second memories and (ii) a second data path for the first and second information via the respective first and second memories, on an exclusive basis according to the selection control signal; and
outputting corresponding data to the register circuit through one of the first and second data paths selected.

17. A communications interfacing method according to claim 16, wherein the performing step instructs the information writing operation to write the first and second information into the first and second memories, respectively, in accordance with an access performed by the host computer,
wherein the executing step instructs the information reading operation to start reading the first and second information from the first and second memories, respectively, upon a time the information writing operation starts writing the first and second information into the first and second memories, respectively, and
wherein the method further comprises the steps of:
detecting memory statuses of the first-in and first-out memories included in the respective first and second memories, using the control circuit;
outputting a status signal representing the memory statuses detected; and
controlling the selecting step by the control circuit in accordance with a status as to whether the operation mode of the apparatus is the low power consumption mode and the status signal output from the status detecting circuit block.

18. A communications interfacing method according to claim 10, wherein the register, the first and second memories, and the control circuit are integrated into a single integrated chip.

19. An optical disk drive apparatus, comprising:
an optical disk drive mechanism; and
an interface circuit for interfacing communications, between the optical disk drive mechanism and a host computer, the interfacing circuit comprising:
an input terminal for receiving data sent from the host computer;
a data processor configured to perform a predetermined data processing operation to the data received through the input terminal;
a clock generator configured to generate a clock signal with which the data processor performs the predetermined data processing operation;
an operation mode changer configured to control the clock generator to reduce a frequency of the clock signal to a value smaller than a predetermined value to change an operation mode from a regular operation mode to a low power consumption mode;
a buffering circuit block configured to buffer the data received through the input terminal, the buffering circuit block including:
a first data transfer path configured to transfer the data received through the input terminal to the data processor not via a memory, and
a second data transfer path configured to transfer the data received through the input terminal to the data processor via a memory; and
a path selection controller configured to control the buffering circuit clock to select the second data transfer path on an exclusive basis when the operation mode is changed from the regular operation mode to the low power consumption mode.
